(19) United States
(12) Patent Application Publication
(10) Pub. No.: US 2013/0198240 A1
(43) Pub. Date: Aug. 1, 2013

(54) Social Network Analysis

(71) Applicants: Sihem AMERI-YAHIA, Doha (QA); Andrey Gubichev, Doha (QA)

(72) Inventors: Sihem AMERI-YAHIA, Doha (QA); Andrey Gubichev, Doha (QA)

(73) Assignee: Qatar Foundation, Doha (QA)

(21) Appl. No.: 13/434,508

(22) Filed: Mar. 29, 2012

(30) Foreign Application Priority Data
Jan. 27, 2012 (GB) 1201369.4

(51) Int. Cl. G06F 17/30

(52) U.S. Cl. 707/798; 707/E17.011

(57) ABSTRACT

A computer-implemented method for analysing user traffic at a website that includes an article on at least one page, wherein the or each page includes a file stored at a website file server, the method comprising determining a set of topics for the article by computing respective measures for the probabilities of keywords appearing in the article, generating a graph representing actions performed on the article by a user, determining a set of shortest paths between respective ones of nodes of the graph, and computing a statistical measure for user traffic at the website.

### CROSS REFERENCE TO RELATED APPLICATIONS

This application claims foreign priority from UK Patent Application Serial No. 1201369.4, filed 27 Jan. 2012.

### BACKGROUND

With the emergence and rapid proliferation of social media, such as instant messaging, sharing sites, blogs, wikis, microblogs and social networks for example, content can be produced which exists in a highly connected web of contexts (such as social groups, geographic locations, time and so on) and which is attributable to its creator. Social media functionality is now commonly integrated into websites allowing users to share information and provide commentary on a wide range of topics. For example, many news websites allow users to comment on stories or articles, and also embed the functionality into their sites to allow users to share content and indicate their approval (or not) of a particular item on the site in question.

Analytics tools, for example those provided by Google® Analytics™ are used to provide insights on incoming traffic and coarse aggregates (e.g., average time spent, traffic source and so on) for websites. Those aggregates, however, do not account for user interest nor do they incorporate individual user actions on the site.

### SUMMARY

According to an example, there is provided a computer-implemented method for analysing user traffic at a website that includes an article on at least one page, wherein the or each page includes a file stored at a website file server, the method comprising determining a set of topics for the article by computing respective measures for the probabilities of keywords appearing in the article, generating a graph representing actions performed on the article by a user, determining a set of shortest paths between respective ones of nodes of the graph, and computing a statistical measure for user traffic at the website.

Nodes of the graph can represent multiple articles, topics, users and actions for the website and edges between nodes are transitions between actions annotated with time. Nodes can correspond to actions performed on the article by a user. Nodes can include data representing a user identification and a timestamp for the performance of the action on the article by the user in question. Determining a set of shortest paths can include sampling a random subset of the nodes and determining, for each node of the subset, the shortest path to and from every other node in the subset.

According to an example there is provided apparatus for analysing user traffic at a website, comprising a topic extractor to determine a set of topics of an article of the website by computing respective measures for the probabilities of keywords appearing in the article, a graph generator to generate a graph representing actions performed on the article by a user, and determine a set of shortest paths between respective ones of nodes of the graph, and an analytics module to compute a statistical measure for user traffic at the website. The graph generator can process data for the website to determine a set of multiple articles, topics, users and actions for the website representing nodes of the graph, and to determine a set of edges between the nodes to represent transitions between actions annotated with time. The graph generator can determine a set of shortest paths by sampling a random subset of the nodes and determine, for each node of the subset, the shortest path to and from every other node in the subset.

According to an example, there is provided a computer program embedded on a non-transitory tangible computer readable storage medium, the computer program including machine readable instructions that, when executed by a processor, implement a method for analysing user traffic at a website that includes an article on at least one page, wherein the or each page includes a file stored at a website file server, comprising determining a set of topics for the article by computing respective measures for the probabilities of keywords appearing in the article, generating a graph representing actions performed on the article by a user, determining a set of shortest paths between respective ones of nodes of the graph, and computing a statistical measure for user traffic at the website. Nodes of the graph can represent multiple articles, topics, users and actions for the website and edges between nodes are transitions between actions annotated with time. Nodes can correspond to actions performed on the article by a user. Nodes can include data representing a user identification and a timestamp for the performance of the action on the article by the user in question. Determining a set of shortest paths can include sampling a random subset of the nodes and determining, for each node of the subset, the shortest path to and from every other node in the subset.

### BRIEF DESCRIPTION OF THE DRAWINGS

An embodiment of the invention will now be described, by way of example only, and with reference to the accompanying drawings, in which:

FIG. 1 is a schematic block diagram of a system according to an example; and

FIG. 2 is a schematic block diagram of an apparatus according to an example.

### DETAILED DESCRIPTION

According to an example, there is provided a method and apparatus to model the collective behaviour of users on websites which uses timed paths in a graph where nodes contain articles, topics, users and actions and edges are transitions between nodes representing different actions which can be annotated with time. Topics and actions are characteristics for a website and multiple path traversal primitives can be defined which can be used to aggregate these characteristics for a given time period and along four dimensions, such as traffic source, number of visits, visitors, and geographic location of visitors for example. Such primitives can be used to build a topic-centric, action-centric and an experience sharing interface where topics and time can be used to filter and aggregate visits and rank them according to different types of actions they contain.

In an example, a path in a generated graph represents a user visit. One-to-one, one-to-many, and many-to-many path traversal primitives can be used to enable a variety of analytics to be performed on user visits to a website that are produced by filtering, grouping and aggregating on resulting paths. An example is to find all shortest paths that lead to posting a comment on an article on a certain topic and aggregate them by traffic source (e.g., search engines, direct traffic, referring sites and so on). Another example is to find all shortest paths starting at a node representing a certain topic, ending at another node representing another topic, and containing more than a user selected number or percentage of social network ‘shares’ or ‘likes’ for example. The resulting paths can be filtered by the geographic area of users. In an example, resulting paths can be grouped by topic in order to show the most preferred topics.

In an example, a website can include an article about one or more topics. The article can span one or more webpages, each of which can be associated with one or multiple data files which can be stored across any number of web servers or similar. Accordingly, a data file, which can relate to a single article or multiple articles, can include data in the form of text, images and so on as is typical, and which embody content for at least one webpage. A topic for the content can be derived using the data file using a topic extractor to determine and extract topics and keywords from articles using document processing techniques. Typically, a generative probabilistic model such as latent Dirichlet allocation for example, can be used for the corpus of content being considered. For example, a set T of latent topics from articles in S can be discovered, each of which is viewed as a document formed by the words it contains. A topic extractor outputs the probability of a topic generating each word as well as the probability of an article being about a topic.

According to an example, a topic signature T_{sign}(s)={(t,score(s,t)|∀t∈T} is associated with each article s∈S where score(s,t) is the relevance of s to t. The topic signature of a set of articles S′ [symbol] S is denoted Tₛₑₜ(S′)={(t,score(S′,t))|∀t∈T} where score(S′,t)=avg_{s∈S′}score(s,t).

In alternative examples, the topic signature may make use of alternative aggregation functions, such as max or min functions for the set of articles.

Given a set of likely topics which correspond to one or more articles for a website, a graph can be constructed which relates articles for a webpage/website to user traffic as described above. In an example, there exists a set of users U, where each user u has an identifier u_{id} and an ip address location, and a set S of articles. Each article is a tuple of the form <sid, headline, summary, content>. Each user has access to a set S of articles and can perform on every article one or more of several actions drawn from a finite set A which can include actions such as “Browse”, “Share”, “Tweet”, “Comment”, “Like” and so on.

This corresponds to a directed graph G=(V, E) where each node v∈V corresponds to a specific action a∈A that was performed on the article s∈S. The node v is therefore identified by the pair <s,a> and annotated with the set of pairs T(v)={<uid, t(s, a)>}, where uid specifies the user and the timestamp t(s, a) is the time when the action a was performed on the article s by a user u.

For example, two users, Alice and Bob, are browsing a website. Alice browsed news page A at time 1, then she read and shared news article B at times 2 and 4 respectively. Bob only browsed article B at time 3. The resulting graph contains three nodes identified by the pairs <A, Browse>, <B, Browse>, <B, Share>, and annotated with the sets {<Alice, 1>}, {<Alice, 2>, <Bob, 3>}, {<Alice, 4>} respectively.

Consider two nodes in V, u= [symbol] sᵤ,aᵤ [symbol] and v= [symbol] sᵥ,aᵥ [symbol] . According to an example, there is an edge (u,v)∈E if and only if:
1. there exist [symbol] uid,t(sᵤ,aᵤ) [symbol] ∈T(u) and [symbol] uid,t(sᵥ,aᵥ) [symbol] ∈T(v) such that t(sᵤ,aᵤ)<t(sᵥ,aᵥ), and
2. there is no other node w=<s_{w},a_{w}> such that there exists a pair [symbol] uid,t(s_{w},a_{w}) [symbol] ∈T(w) and t(sᵤ,aᵤ)<t(s_{w},a_{w})<t(sᵥ,aᵥ).

In the graph of the example noted above, there are therefore two edges: the first edge from <A, Browse> to <B, Browse>, and the second one from <B, Browse> to <B, Share>.

The same sequence of actions may have been done by different users. That is to say, the edge (u, v) may exist due to actions of different users. In the above example, both Alice and Bob may have browsed and shared article B. Therefore, according to an example, an edge weight w(u, v) is defined as the average time needed to move from u to v among all users.

In an example, a timed path p of length l∈ [symbol] is an ordered sequence of I+1 nodes, such that there exists, for every node in the sequence, an edge to the next node in the sequence, except the last one. The weight of the path p is the sum of weights of edges that constitute the path. The path between two nodes models a user's trajectory on a website. For instance, a user may start by reading an article in the Editorial section of a website (node1), then proceed with sharing it (node2), then read two other articles on Politics (node3 and node4). The shortest path between two nodes is the path with the minimal weight. Informally, the path between two nodes in the graph is the shortest path, if it corresponds to the least time consuming trajectory between those two nodes. To find the restricted shortest path between two nodes, only paths that satisfy some criteria on actions and topics are considered and aggregated along four key dimensions: traffic source, visits, visitors, and geographic location for a given time period. For example, to analyze the trajectories of users that were only reading articles (as opposed to those who also shared, tweeted etc), all paths that consist only of nodes <s, browse> with s∈S need be found.

In order to circumvent the high complexity of path traversal in large graphs, scalable algorithms that approximate shortest paths are used according to an example. Approximating shortest paths can be a pre-computation step which samples sets of random nodes with increasing sizes (from the one-element set to the whole V) in a graph as described above, and for every node in the graph determines the shortest path to and from a member of this set, and stores these paths. The closest member of the sample set to the node u is termed a landmark for u. In other words, the landmark for u is the end node of the shortest path from u to some sample set, or the start node on the shortest path from some set to u. Accordingly, the sketch of a node u is defined as the set of landmarks and corresponding paths. These sketches for every node are stored and used later.

According to an example, given a start node s∈V in a graph, and end nodes d₁, . . . , dₖ∈V, a goal is to determine the shortest paths between s and every one of dᵢ. A set of query nodes s,d₁, . . . , dₖ provide input for a graph generator which can output sketches for all the query nodes. The sketch sketch(v) of a node v contains two sets of paths: (1) the set of paths connecting v to landmarks (called forward-directed paths) and (2) the set of paths connecting landmarks to v (called backward-directed paths). Forward-directed paths from a sketch(s) form a subgraph G_{f} of the graph G. Likewise, the union of all backward-directed paths from the sketches sketch(d₁), . . . , sketch(dₖ) forms the subgraph G_{b} of the graph G. The node s is the source node in G_{f}, whereas d₁, . . . , dₖ are the sink nodes in G.

According to an example, two simultaneous Breadth-First are executed from the source and the sink nodes. The first process, bfs(G_{f}), follows the forward links, while the second bfs(G_{b}) is run on the reversed links. For every couple of nodes visited by both processes it is checked whether these nodes are neighbours in the original graph. If yes, the path by concatenating the pieces of paths from G_{f}, G_{b} and the edge (u, v) is concatenated.

Two bfs processes terminate once they reach the landmarks of s and d₁, . . . , dₖ. Since the graph G is connected, there are common landmarks for s and d₁, . . . , dₖ. The corresponding paths are constructed and added to the queue. The one-to-one shortest paths algorithm builds on the one-to-many algorithm by considering one end node and running the one-to-many algorithm. In an example, a process as described in A. Gubichev, S. Bedathur, S. Seufert, and G. Weikum, Fast and accurate estimation of shortest paths in large graphs, CIKM'10, pages 499-508, the contents of which are incorporated herein in their entirety by reference, can be used.

The many-to-many shortest paths algorithm is typically a simple generalization of the one-to-many case for several start nodes. Restricted shortest paths are computed using a post filtering phase where metadata associated to nodes in the graph in the form of user location and article topics is used.

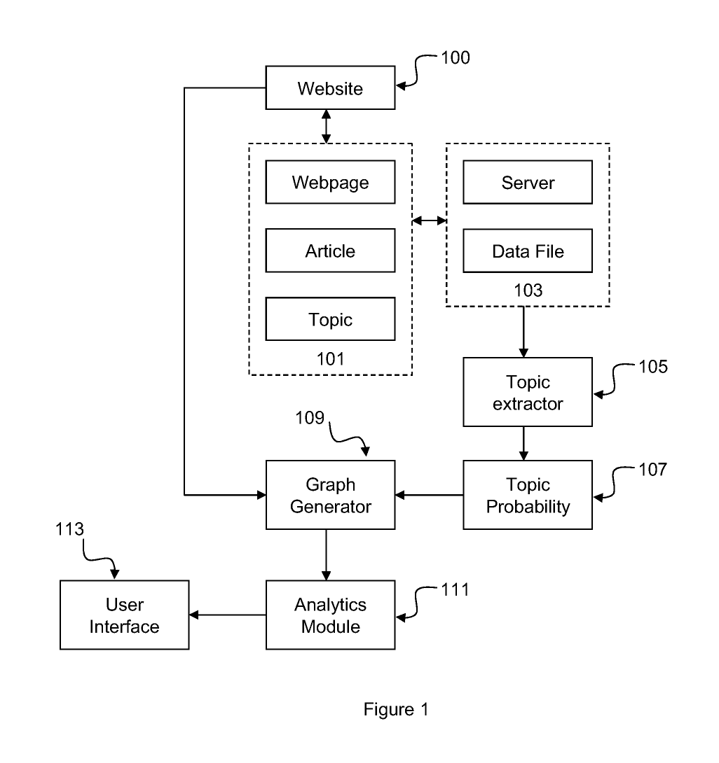

FIG. 1 is a schematic block diagram of a system according to an example. A website 100 includes a webpage which can comprise an article relating to a topic, 101. Content for the webpage is stored as a data file on a server, 103. Topic extractor 105 processes data from the data file in order to determine a set of topics for the webpage, and more specifically, a set of topics which are the subject of the article. A probability 107 is associated with the topics and represents a measure for the likelihood that the article is about a topic. That is, a higher probability indicates a greater degree of certainty that the article contains content on a certain topic which has been extracted from the content by the topic extractor 105.

Graph generator 109 is used to generate a graph which maps traffic at website 100 as described above. The generator 109 uses the topics determined by topic extractor 105. For example, only those topics with a probability 107 above a threshold value may be used. Alternatively, all extracted topics may be used, or a predefined number may be used.

A graph generated by generator 109 relates actions performed by users on aspects of the website 100. As described above for example, users can interact with an article on a webpage of the website 100 by performing certain actions in connection with the article. For example, the article can be read, shared, commented on and so on. The generated graph for the website 100 therefore includes a set of nodes representing specific actions performed on articles for the website 100. An edge between nodes is a weighted average between actions of users as described above.

An analytics module 111 enables a graph generated by generator 109 to be analysed in order for a user of a system according to an example to generate measure and statistics for traffic of the website 100. In an example, a user interface 113 for a user can be used to summarise web traffic to a website 100 in one of multiple ways. For example, user visits in a selected period can be displayed. A part of the UI 113 can display a geographic distribution of topics, such as those with shortest paths to a Share action for example. The distribution can be obtained by grouping paths according to the origin of users and displaying topics covered by their visits. In an example, a font size for the UI 113 of a displayed topic can be used to reflect the average time spent sharing articles on the topic. A dropdown menu can allow filtering of actions, in which case a collection of shortest path primitives can be generated and their results grouped and aggregated by geography and topic on-the-fly.

A scale bar can be used to set different bounds on time spent performing the elected action and can affect topics displayed. In an example, those topics on which users spent at least a third of their time sharing articles can be displayed.

Another analytics interface can show global statistics, such as the overall number of paths and a breakdown of time spent per topic for each visit for example. A bounce rate indicates the percentage of single-node paths by topic thereby providing an insight on the stickiest topics. A set of charts, such as pie charts for example can show a breakdown of average time spent per topic for each visit. A second collection of charts can show the average time spent per topic on the start node of each visit grouped by traffic source (e.g., search engine, referring site and so on). A second interface can be used to show statistics in an action-centric way.

In an example, an experience sharing interface can also be provided in which users can select a region and a time period of interest. Additionally, a user can specify multiple filtering conditions on topics (start and end node of visit) and time (maximum time spent per visit) for example. Resulting paths can be ranked according to different types of actions they contain (such as Most Commented, Most Shared, Most Browsed and so on) for example. Returned paths represent individual user visits and contain nodes labelled with articles and edges labelled with average time spent.

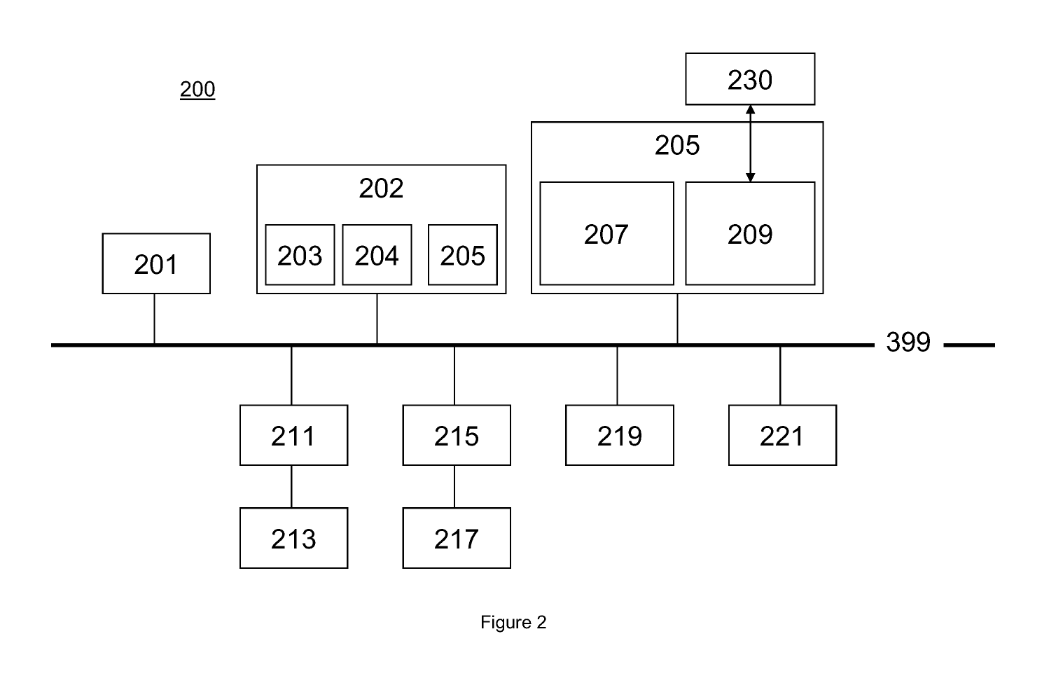

FIG. 2 is a schematic block diagram of an apparatus according to an example suitable for implementing any of the systems, methods or processes described above. Apparatus 200 includes one or more processors, such as processor 201, providing an execution platform for executing machine readable instructions such as software. Commands and data from the processor 201 are communicated over a communication bus 399. The system 200 also includes a main memory 202, such as a Random Access Memory (RAM), where machine readable instructions may reside during runtime, and a secondary memory 205. The secondary memory 205 includes, for example, a hard disk drive 207 and/or a removable storage drive 230, representing a floppy diskette drive, a magnetic tape drive, a compact disk drive, etc., or a nonvolatile memory where a copy of the machine readable instructions or software may be stored. The secondary memory 205 may also include ROM (read only memory), EPROM (erasable, programmable ROM), EEPROM (electrically erasable, programmable ROM). In addition to software, data representing any one or more of a website 100, webpage, article, topic, 101, topic extractor 105, graph generator 109, analytics module 111 or topic probability 107 may be stored in the main memory 202 and/or the secondary memory 205. The removable storage drive 230 reads from and/or writes to a removable storage unit 209 in a well-known manner.

A user can interface with the system 200 with one or more input devices 211, such as a keyboard, a mouse, a stylus, and the like in order to provide user input data. The display adaptor 215 interfaces with the communication bus 399 and the display 217 and receives display data from the processor 201 and converts the display data into display commands for the display 217. A network interface 219 is provided for communicating with other systems and devices via a network (not shown). The system can include a wireless interface 221 for communicating with wireless devices in the wireless community.

It will be apparent to one of ordinary skill in the art that one or more of the components of the system 200 may not be included and/or other components may be added as is known in the art. The apparatus 200 shown in FIG. 2 is provided as an example of a possible platform that may be used, and other types of platforms may be used as is known in the art. One or more of the steps described above may be implemented as instructions embedded on a computer readable medium and executed on the system 200. The steps may be embodied by a computer program, which may exist in a variety of forms both active and inactive. For example, they may exist as software program(s) comprised of program instructions in source code, object code, executable code or other formats for performing some of the steps. Any of the above may be embodied on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running a computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated above may be performed by any electronic device capable of executing the above-described functions.

According to an example, a graph generator 203, topic extractor 204 and analytics module 205 can reside in memory 202 and operate on data representing a website, such as data file 103.

1. A computer-implemented method for analysing user traffic at a website that includes an article on at least one page, wherein the one or each page includes a file stored at a website file server, the method comprising:
determining a set of topics for the article by computing respective measures for the probabilities of keywords appearing in the article;
generating a graph representing actions performed on the article by a user where edges between nodes are transitions between actions annotated with time;
determining a set of shortest paths between respective ones of nodes of the graph; and
computing a statistical measure for user traffic at the website.

2. A computer-implemented method as claimed in claim 1, wherein nodes of the graph represent multiple articles, topics, users and actions for the website.

3. A computer-implemented method as claimed in claim 1, wherein nodes correspond to actions performed on the article by a user.

4. A computer-implemented method as claimed in claim 1, wherein nodes correspond to actions performed on the article by a user, and wherein nodes include data representing a user identification and a timestamp for the performance of the action on the article by the user in question.

5. A computer-implemented method as claimed in claim 1, wherein determining a set of shortest paths includes sampling a random subset of the nodes and determining, for each node of the subset, the shortest path to and from every other node in the subset.

6. Apparatus for analysing user traffic at a website, comprising:
a topic extractor operable to determine a set of topics of an article of the website by computing respective measures for the probabilities of keywords appearing in the article;
a graph generator operable to:
generate a graph representing actions performed on the article by a user; and to determine a set of edges between the nodes to represent transitions between actions annotated with time; and determine a set of shortest paths between respective ones of nodes of the graph; and
an analytics module operable to compute a statistical measure for user traffic at the website.

7. Apparatus as claimed in claim 6, the graph generator being operable to process data for the website to determine a set of multiple articles, topics, users and actions for the website representing nodes of the graph.

8. Apparatus as claimed in claim 6, the graph generator being operable to determine a set of shortest paths by sampling a random subset of the nodes and determine, for each node of the subset, the shortest path to and from every other node in the subset.

9. A computer program embedded on a non-transitory tangible computer readable storage medium, the computer program including machine readable instructions that, when executed by a processor, implement a method for analysing user traffic at a website that includes an article on at least one page, wherein the one or each page includes a file stored at a website file server, comprising:
determining a set of topics for the article by computing respective measures for the probabilities of keywords appearing in the article;
generating a graph representing actions performed on the article by a user, where edges between nodes are transitions between actions annotated with time;
determining a set of shortest paths between respective ones of nodes of the graph; and
computing a statistical measure for user traffic at the website.

10. A computer program embedded on a non-transitory tangible computer readable storage medium as claimed in claim 9, the computer program further including machine readable instructions that, when executed by a processor, implement a method for analysing user traffic at a website wherein nodes of the graph represent multiple articles, topics, users and actions for the website.

11. A computer program embedded on a non-transitory tangible computer readable storage medium as claimed in claim 9, the computer program further including machine readable instructions that, when executed by a processor, implement a method for analysing user traffic at a website wherein nodes correspond to actions performed on the article by a user.

12. A computer program embedded on a non-transitory tangible computer readable storage medium as claimed in claim 11, the computer program further including machine readable instructions that, when executed by a processor, implement a method for analysing user traffic at a website wherein nodes correspond to actions performed on the article by a user, and wherein nodes include data representing a user identification and a timestamp for the performance of the action on the article by the user in question.

13. A computer program embedded on a non-transitory tangible computer readable storage medium as claimed in claim 9, the computer program further including machine readable instructions that, when executed by a processor, implement a method for analysing user traffic at a website wherein determining a set of shortest paths includes sampling a random subset of the nodes and determining, for each node of the subset, the shortest path to and from every other node in the subset.
